(19) United States
(12) Patent Application Publication
(10) Pub. No.: US 2015/0157964 A1
(43) Pub. Date: Jun. 11, 2015

(54) TRANSPORTABLE WATER FILTRATION SYSTEMS AND METHODS

(71) Applicant: Smith Transport, Inc., Roaring Spring, PA (US)

(72) Inventor: Ryan Michael Horchen, DuBois, PA (US)

(21) Appl. No.: 14/566,270

(22) Filed: Dec. 10, 2014

Related U.S. Application Data
(60) Provisional application No. 61/914,207, filed on Dec. 10, 2013.

(51) Int. Cl. B01D 29/68; C02F 1/00

(52) U.S. Cl. CPC B01D 29/68; C02F 1/001; C02F 2103/10

(57) ABSTRACT

Water filtration systems and methods for use in industries such as the oil and gas industry are disclosed. The filtration systems and methods may be used to treat water recovered from hydraulic fracturing operations, drilling operations and the like.

### CROSS-REFERENCE TO RELATED APPLICATION

This application claims the benefit of U.S. Provisional Patent Application Ser. No. 61/914,207 filed Dec. 10, 2013, which is incorporated herein by reference.

### FIELD OF THE INVENTION

The present invention relates to water filtration systems and methods, and more particularly relates to transportable water filtration systems and methods that may be used to treat water in the oil and gas industry, and in other industries.

### BACKGROUND INFORMATION

In the oil and gas industry, wastewater is generated from operations such as hydraulic fracturing, drilling and the like. It would be desirable to provide an effective and efficient system and method for treating such wastewater.

### SUMMARY OF THE INVENTION

The present invention provides water filtration systems and methods for use in industries such as the oil and gas industry. The filtration systems and methods may be used to treat water recovered from hydraulic fracturing operations, drilling operations and the like. The system reduces the cost of filtration, adds efficiency to the filtration process, and reduces the environmental impact.

An aspect of the present invention is to provide a transportable wastewater treatment system comprising: a raw water pump; a filtration unit comprising a plurality of disk filters, wherein each disk filter comprises a raw water inlet line in flow communication with the raw water pump and a clean water outlet line; and a backwash pump comprising a backwash water inlet line in flow communication with a source of backwash water, and a backwash water outlet line in flow communication with the clean water outlet line of each of the disk filters.

Another aspect of the present invention is to provide a method of treating wastewater comprising: pumping raw water through a plurality of disk filters to remove particulates contained in the raw water and to produce clean water; and periodically backwashing a selected one or more of the disk filters to remove trapped particulates from the one or more disk filters, wherein the disk filters are housed in a transportable container.

These and other aspects of the present invention will be more apparent from the following description.

### BRIEF DESCRIPTION OF THE DRAWINGS

FIG. 1 is a schematic flow diagram illustrating features of a water filtration system in accordance with an embodiment of the present invention.

FIG. 2 is a partially schematic diagram illustrating various components of a water filtration system in accordance with an embodiment of the present invention.

FIG. 3 is a front view of a filtration unit for a water filtration system in accordance with an embodiment of the present invention.

FIG. 4 is a top view of the filtration unit of FIG. 3.

FIG. 5 is a side view of the filtration unit of FIG. 3.

### DETAILED DESCRIPTION

In accordance with embodiments of the invention, the water filtration systems comprise transportable and/or self-contained units that can be mobilized to any desired location. An efficient, clean and safe work environment is provided for the filtration process.

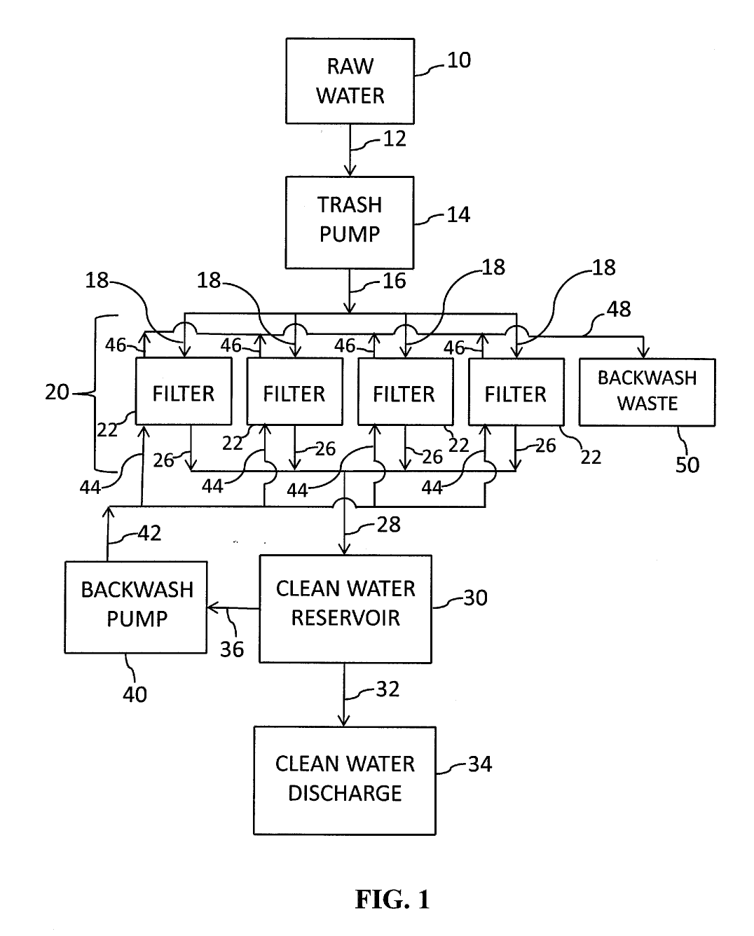

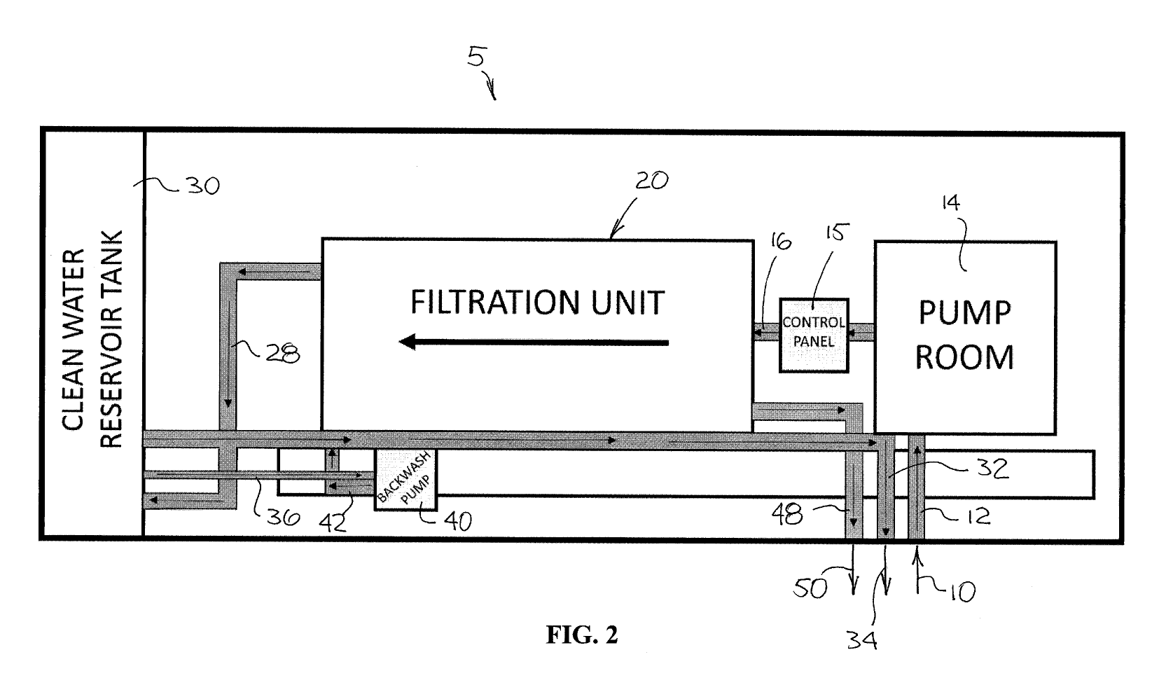

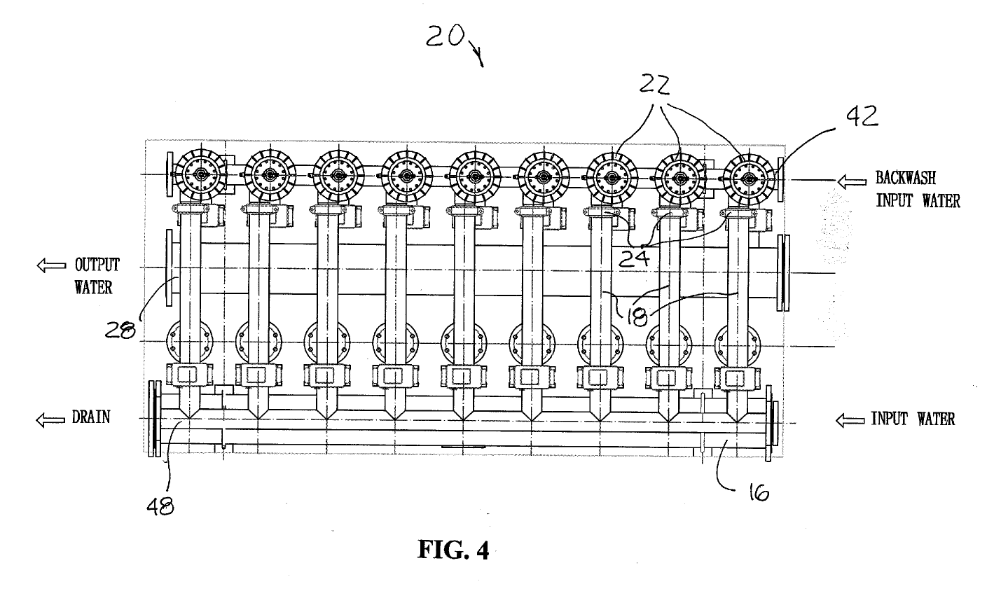

FIGS. 1-5 illustrate various aspects of a water filtration system 5 in accordance with an embodiment of the present invention. As shown in FIGS. 1 and 2, the water filtration system 5 includes a source of raw water 10, such as water recovered from hydraulic fracturing operations, drilling operations, or the like in the oil and gas industry. The raw water is fed through an inlet feed line 12 to a raw water pump 14. In certain embodiments, the raw water pump 14 comprises a trash pump capable of operating at a sufficiently high pressure to perform the filtering operation as well as the filter flushing operations, as more fully described below. A minimum pressure of 30 psi may typically be maintained, for example, a minimum pressure of 35 psi may be maintained. In addition, the raw water pump 14 is capable of providing a sufficient water flow rate, typically greater than 100 GPM, for example, greater than 200 GPM. The raw water pump 14 maintains the selected pressure levels and flow rates during operation of the system, e.g., during treatment of recovered hydraulic fracturing water or down hole drilling water in the oil and gas production industries. A control panel 15 may be used to control the flow of the raw water from the raw water pump 14 through a raw water inlet manifold 16 to several raw water inlet feed lines 18.

As shown in FIGS. 1-5, the wastewater treatment system 5 includes a filtration unit 20 comprising multiple filters 22. Each filter 22 includes a filter inlet 24 and a filter outlet 26. Each filter outlet 26 feeds into an outlet manifold 28, which feeds into a clean water reservoir 30. Clean water contained in the clean water reservoir 30 may be fed through a clean water outlet line 32 to a clean water discharge.

The disk filters 22 may comprise thin, color-coded polypropylene disks that are diagonally grooved on both sides to a specific micron size. A series of these disks are then stacked and compressed on a specially designed spine. When stacked, the diagonal grooves on top of a disk run opposite to the diagonal grooves on an adjacent disk, creating a filtration element with a statistically significant series of valleys and traps for solids. The stack is enclosed in a corrosion and pressure resistant housing. During the filtration process, the filtration disks are tightly compressed together by the spring's power and the differential pressure, thus providing high filtration efficiency. Filtration occurs while water is percolating from the peripheral end to the core of the element.

In accordance with an embodiment of the invention, the filters 22 comprise disk filters such as those commercially available from Nea Netafim, Ltd. and Shandong Sihai Water Treatment Equipment Co. LTD.

As shown in FIGS. 1 and 2, a backwash pump 40 may be used to clean the filters 22 by a backflow of water. In the embodiment shown, the backwash water may be fed from the clean water reservoir 30 through backwash inlet feed lines 36 to the backwash pump 40. While the backwash water comes from the clean water reservoir 30 in the embodiment shown in the figures, it is to be understood that any other suitable source of clean water may be used. The backwash water is fed from the backwash pump 40 through a backwash inlet manifold 42 into backwash feed lines 44. Each backwash feed line 44 feeds into a filter 22, e.g., using the filter outlet line 26 of each filter 22. Backwash water exits the filters 22 via backwash outlet lines 46. Each backwash outlet line 46 feeds into a backwash outlet manifold 48, which feeds into a backwash waste receptacle 50.

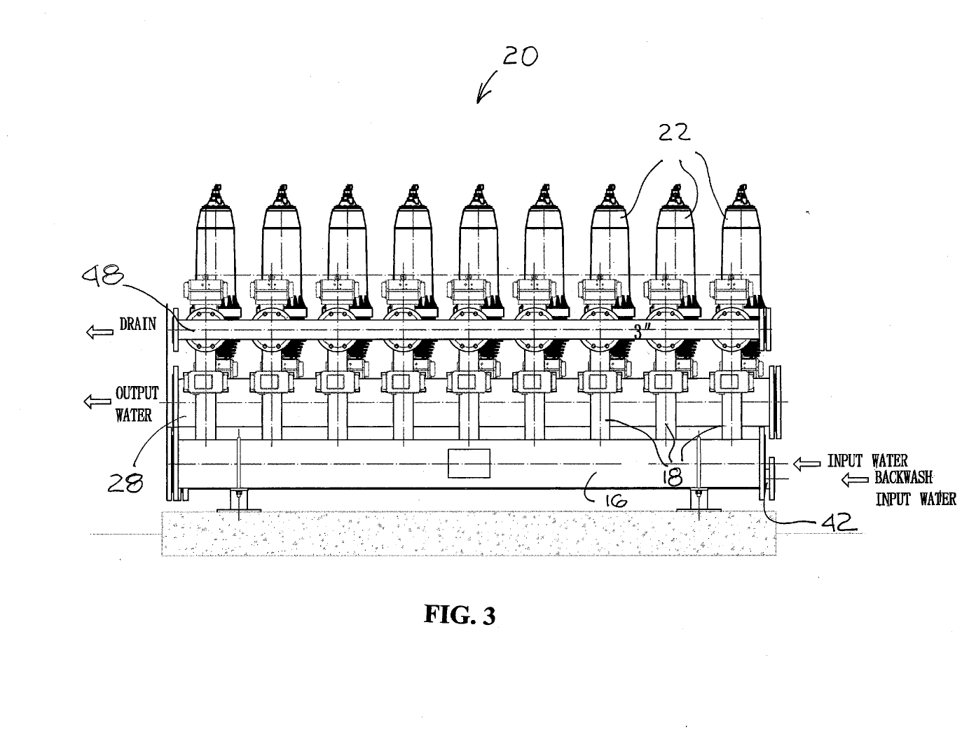

For purposes of clarity, the backwash feed line 44 and filter outlet 26 for each filter 22 are shown as separate lines in FIG. 1. In addition, the backwash outlet line 46 and raw water inlet feed line 18 for each filter 22 are shown as separate lines in FIG. 1. However, it is to be understood that the backwash feed line 44 and filter outlet 26 may comprise the same line, and the backwash outlet line 46 and raw water inlet feed line 18 may comprise the same line, as shown in FIGS. 3-5.

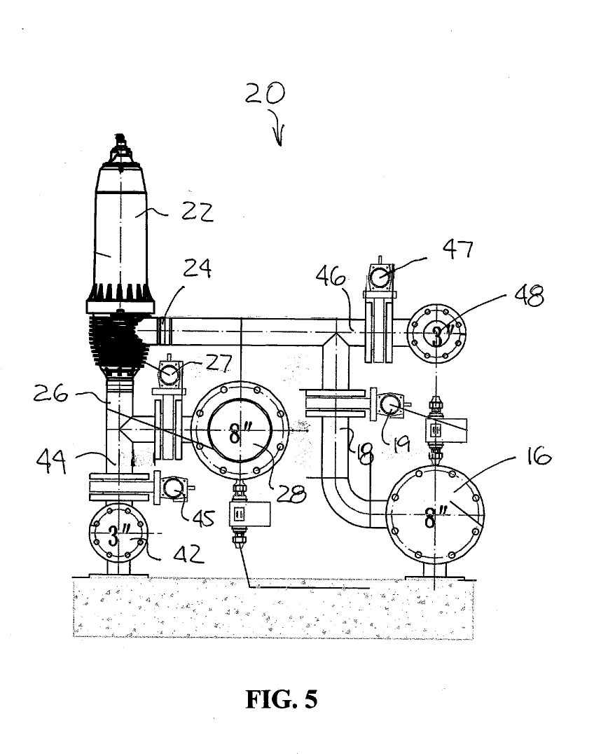

FIGS. 3-5 illustrate features of the filtration unit 20 in accordance with an embodiment of the present invention. The raw water inlet manifold 16 feeds into the inlet lines 18 which, in turn, feed into the filters 22. The filters 22 discharge into the filter outlets 26, which feed into the outlet manifold 28. The backwash inlet manifold 42 feeds into the backwash feed lines 44 which, in turn, feed into the outlet 26 of each filter 22. After the backwash water has been fed through each filter 22, the backwash water flows via backwash outlets 46 into the backwash outlet manifold 48. As shown in FIG. 5, a raw water inlet valve 19 may be used to control the flow of water through each inlet feed line 18, while an outlet valve 27 may be used to control the flow of water from each filter outlet 26 to the outlet manifold 28. A backwash inlet valve 45 may be used to control the flow of backwash water through each backwash feed line 44, while a backwash outlet valve 47 may be used to control the flow of water through each backwash outlet line 46. The valves 19, 27, 45 and 47 may be used to control the flow rate and flow direction within each disk filter unit 22. In the embodiment shown in FIGS. 3-5, nine filters 22 are used. However, it is to be understood that any suitable number of filters may be used in accordance with the present invention. For example, two or more filters may be used, e.g., at least five or eight filters may be used.

The water filtration system 5 in accordance with an embodiment of the present invention may operate as follows. Raw water to be treated enters the system via the inlet line 12 connected to the pump 14 that is designed to handle water recovered during oil and gas drilling, hydraulic fracturing and production operations. In certain embodiments, the pump may comprise a trash pump having relatively small vanes, e.g., from 0.5 to 1.5 inch, or about 1 inch. This allows the suspended solids pass to the filter for filtration without clogging the pump, but with a build pressure in excess of, e.g., 50 psi. An adjustable flow gate may also be used to build even more back pressure against the system while maintaining flow, as well as giving the filtration system more time to filter efficiently. The pump 14 feeds the raw water to the inlet manifold 16, which then feeds the water to the series of disk filters 22 via the series of feed lines 18. Each disk filter unit 22 removes particulates from the raw water and passes the cleaned water to the outlet manifold 28. The clean water exits the outlet manifold 28 via the reservoir 30 and outlet line 32.

In accordance with embodiments of the present invention, the dirty water flowing into each disk filter unit 22 flows circumferentially around stacked disks, and is forced radially inward between adjacent grooved surfaces of the disks. Particulates are trapped within the grooved regions between the disks. The filtered water travels radially inward and is drawn axially downward through the center of the filter stack, where it exits each disk filter unit 22 into the outlet manifold 28.

The controller 15 may be used to control the timing of back flushing and cleaning cycles, which may be set by the operator and/or determined by how dirty the water is. The controller may also control the pressure of the back flush and cleaning cycles, e.g., the operator can set it for 10 psi pressure variant across the filter which will trigger a cleaning cycle. The controller may further be used to control both the timing and the pressure, e.g., the operator can set a time trigger or pressure trigger and, whichever comes first, will begin a cleaning cycle.

The controller 15 may be used to control the purge cycles of the disk filters 22, e.g., by selective control of the valves 19, 27, 45 and 47. For example, the controller 15 may be used to sequentially trigger the back-washing of individual disk filters 22 while the other disk filters 22 remain in filtration mode. The controller 15 may sequentially send signals periodically to the disk filters 22 to initiate a back-washing operation in each disk filter 22. For example, a different disk filter may be back-washed every 10 to 30 minutes.

In addition to such timed back-washing operations, the controller 15 may signal back-washing operations based upon a sensed pressure drop in the system. For example, pressure sensors located in the inlet 16 and outlet 28 manifolds may be used to indicate a pressure drop that causes the controller 15 to trigger a back-washing operation in one or more of the disk filters 22. For example, if a pressure drop of 10 percent is sensed, the controller 15 may initiate back-washing of one of the disk filter units 22, followed by sequential back-washing of other disk filter units 22 until the pressure is brought back up to the desired level.

In accordance with embodiments of the present invention, the filtration system may be used to treat water containing particles that may range in size up to 0.5 inch, typically up to 0.25 inch or up to 0.1 inch. The system may be used to remove particles down to sizes of 50 to 200 microns or less, e.g., depending upon the filter disks used. During the treatment of hydraulic fracturing water, particulates such as sand and stones are removed from the water, while allowing any chemicals contained in the water to pass through the system. In this manner, the hydraulic fracturing water may be recycled with its desired chemical composition maintained, but with unwanted particulates removed.

In accordance with embodiments of the present invention, the system may include one or more conventional pressure sensors and gauges (not shown). Water pressure sensors may be used to measure the pressure at the pump inlet, the pump discharge, the inlet manifold and the outlet manifold. In addition, air pressure sensors may be provided in each disk filter unit. The present system may also include one or more flow meter, e.g., located downstream from the outlet manifold.

In an embodiment of the invention, the water filtration system is operated as follows. Dirty or contaminated raw water may be brought to the unit, e.g., via a self-contained four-inch water transfer pump. The raw water may travel through the raw water pump 14, building pressure on the way to the filter arrangement 20. For example, 410 GPM at 3200 RPM and a pressure differential across the filter at 38 psi may be maintained by the raw water pump 14. Greater pressure can be achieved by using a flow gate. Pressure gains of 10 psi cause a loss of only 10 GPM if needed, and the flow rate can be increased as well with a simple change in filtration parameters. The flow data may be recorded by a flow meter that reads and records the GPM filtered at discharge. The produced clean water then exits the unit at a discharge manifold and travels through, e.g., a four-inch discharge hose to the desired location, i.e., a collection pond or holding tank. Particulates may be collected in a separate holding tank, which may then be disposed of, e.g., by the drilling company.

Whereas particular embodiments of this invention have been described above for purposes of illustration, it will be evident to those skilled in the art that numerous variations of the details of the present invention may be made without departing from the invention as defined in the appended claims.

What is claimed is:

1. A transportable wastewater treatment system comprising:
a raw water pump;
a filtration unit comprising a plurality of disk filters, wherein each disk filter comprises a raw water inlet line in flow communication with the raw water pump and a clean water outlet line; and
a backwash pump comprising a backwash water inlet line in flow communication with a source of backwash water, and a backwash water outlet line in flow communication with the clean water outlet line of each of the disk filters.

2. The transportable wastewater treatment system of claim 1, wherein the filtration unit comprises at least 5 of the disk filters.

3. The transportable wastewater treatment system of claim 1, wherein backwash water exits each of the disk filters through the raw water inlet line of each of the disk filters.

4. The transportable wastewater treatment system of claim 1, wherein the raw water pump, filtration unit, and backwash pump are housed in a transportable container.

5. The transportable wastewater treatment system of claim 4, wherein the transportable container also includes a control panel therein.

6. The transportable wastewater treatment system of claim 5, wherein the control panel includes a controller for selectively controlling the flow of the raw water and the backwash water through the filtration unit.

7. The transportable wastewater treatment system of claim 4, wherein the transportable container also includes a clean water reservoir tank.

8. A method of treating wastewater comprising:
pumping raw water through a plurality of disk filters to remove particulates contained in the raw water and to produce clean water; and
periodically backwashing a selected one or more of the disk filters to remove trapped particulates from the one or more disk filters,
wherein the multiple disk filters are housed in a transportable container.
